(19) United States
(12) Patent Application Publication
(10) Pub. No.: US 2006/0252304 A1
(43) Pub. Date: Nov. 9, 2006

(54) Method and power feed for electrical inspections

(76) Inventors: Steven Glen Shoop, Fallbrook, CA (US); Stephen Cameron Fonnby, San Diego, CA (US); Tim Rikkeri, San Diego, CA (US)

Correspondence Address: NYDEGGER & ASSOCIATES, 348 OLIVE STREET, SAN DIEGO, CA, 92103, US

(21) Appl. No.: 11/122,550

(22) Filed: May 5, 2005

(51) Int. Cl. H01R 33/945

(52) U.S. Cl. 439/517

(57) ABSTRACT

A device and method for easily and safely providing temporary electric power to buildings to permit inspection of electrical circuits. The device is a power connector configured to safely and easily provide temporary power to a building unit through receptacles of a standard power meter socket. The connector has at least two spades, a GFCI circuit breaker with a male plug designed to connect the connector to a temporary power source at the electric potential needed for the building. For a typical residence in the United States, this would be a four-prong 120/240 volts ac plug. In preferred embodiments the power connector has the approximate shape of the back side of a standard power meter and the male plug is at the end of a short 120/240 four wire electric power cable. This preferred embodiment also includes three toner posts (two “hot” posts and one neutral post on the load side of the GFCI breaker) for application of a tone from a toner device. Also, in preferred embodiment a protective device is provided to prevent the circuit breaker from being closed unless the connector is installed in the power meter socket. This assures that no power is provided to the spades while they are exposed outside the power meter socket.

This invention relates to methods and devices useful for making electrical inspections of electrical facilities in buildings.

### BACKGROUND OF THE INVENTION

### Electric Power for New Buildings

In the United States there are typically about 2,000,000 new homes constructed each year. These new homes include single family homes, town houses, condominiums, and apartments in apartment buildings. Also constructed each year are many thousands of new commercial and industrial buildings.

### Typical Main Breakers, Power Meters and Circuits

All (or almost all) of these homes and buildings have a single main electrical power supply where a main power circuit breaker for the building is located along with several subsidiary circuit breakers that protect individual electric branch circuits within the home or building. For example, a typical three bedroom 2,000 square foot single family home might have a main power panel with a main breaker and 20 individual branch circuit breakers. Also, located in the main electric panel or in some cases in a separate panel near the main panel is a socket for an electric power meter. A typical example is a main panel that is marketed as “200 Amp Meter Socket/Main/All-In-One” (Model No. MBE2040B200. It is available from Eaton Corporation with offices in Cleveland, Ohio. This panel includes an electric power meter socket. FIG. 4 is sketch of the socket. Shown at 2A and 2B are line-side spade receptacles (called “jaws”) and shown at 4A and 4B are building-side spade receptacles. Four prongs called “spades” on the back side of standard power meters fit tightly in these receptacles. The top two receptacles provide 240 volt ac power from the power company power system to the two spades at the top-input side of the power meter. The power meter when installed in its socket is wired in series with the electric circuit of the building it meters. All electric power consumed in the building flows through the power meter which measures that power in kilowatt hours.

The power leaving the power meter flows out through two bottom spades into the main circuit breaker which protects all of the electrical bussing in the main electrical service panel. For a typical 120/240 volt power service, in addition to two “hot” wires (usually with black or red insulation) providing the 240 volt ac electric potential, the power company provides a third neutral wire (usually with white insulation) and there is also a fourth ground wire with green insulation provided by the installer of the electric system. The ground wire generally connected to a grounding rod or a cold water pipe. The neutral and ground wires typically are not connected to the power meter but are connected to a ground/neutral buss. Aground may also be provided by a grounding rod such as reinforcing bar within a concrete slab. The two hot wires furnish 240 volt power to equipment such as electric dryers and electric stoves. Most other circuits are at 120 volts which is the potential between one of the hot wires and the neutral wires.

### Electrical Inspections

During the earliest stages of construction of a building, temporary power is provided at building sites for electric power tools used in the construction process. During the course of construction the main circuit breaker panel and the branch breakers will be installed along with electric circuits that will ultimately provide electric power throughout the building. Typically, however, no power is provided to these circuits until the entire electric installation is completed and all circuits are in place hopefully properly protected by the main circuit breaker and the individual branch circuit breakers. Electric codes do not permit a permanent electric connection to be made to the building until the electrical circuits have passed an electrical inspection usually made by an employee of a local inspecting authority. Prior to this formal inspection, electrical contractors (responsible for the electric installations) perform a preliminary inspection to determine if defects exist and, if they do, to correct them prior to the formal inspection. This preliminary inspection requires the building to be energized or “heated up” with temporary electric power. Many techniques have been used to provide this temporary power for checking the electric circuits in the building. Two techniques commonly used are described below to “heat up” the building with 120/240 electrical power.

### Prior Art 120/240 Volt Heating-Up Techniques

One common technique is to strip all of the insulation from two short pieces (approximately 3-4 inches long) of Romex (solid copper wire) and force the solid copper wire into the two lower power receptacles 4A and 4B (shown in FIG. 3) in the power meter socket of the main panel, where the lower spades of a meter would locate. The female end of a 240 volt extension cord is cut off, the insulation stripped back to bare wire, and then the stripped ends of the extension cord are taped to the short, bare Romex extending outward from the meter socket. The extension cord is then plugged into a 240 volt receptacle. This applies power to the entire electrical system. This technique and similar techniques produce fire hazards and safety risks. Fire hazards results because:

1) Bare wires used in making temporary power connection can arc, starting a fire; and

2) Any ground fault within system due to improper installation may not be detected and could result in a fire before being detected by inspection. Ground fault protection circuitry exists only where mandated by code (e.g., kitchen, bathroom, garage and outdoor receptacles).

Safety risks to people and equipment also result from the use of these prior art “heating up” techniques:

1) In the event a neutral wire is not properly grounded, the voltage may “float” between the two phases of electricity and over or under voltage the circuit, presenting the possibility of a 240-volt electrical shock to workers, or catastrophic failure of tools and/or equipment;

2) Bare conductors used to connect temporary power could shock workers in vicinity; and 3) Cord currently used could inadvertently be disconnected from panel and leave bare conductors from the temporary power cord energized and open, presenting risks of electrical shock.

A second common technique is to strip the insulation off the two hot wires of an extension cord back to bare wire and feed the bare wires into the load side of a breaker and back-feed the entire electrical system. This carries with it the same attendant fire and electrocution hazards. Also if the temporary connection is left in place and the electric meter is installed by local utility company, utility grid could be back-fed, resulting in risks to utility workers.

A third common technique would be to connect temporary power to either an air conditioning disconnect or a 240 volt ac dryer or oven outlet. This is not preferred due to the fact that it could provide a back feed to the entire system causing risk of electric shock.

### Ground Fault Circuit Interrupters

Ground fault circuit interrupters (GFCI's) are well known. They each contain a small microprocessor that senses tiny current leaks and shuts off the power almost instantly. For example, in a 120 volt ac circuit the current in both wires (hot and neutral) should be the same. If the microprocessor senses a difference of just 1/200 of an amp, it trips the circuit in just about 1/40 of a second or less cutting off power before any serious damage can be done. An example of a GFCI breaker, is Model Number GFCB230, available from the Eaton Corporation, with offices in Cleveland, Ohio

### Typical Toner

Almost all electrical system inspections involve the use of a toner system. A typical toner system comprises a toner (such as Progressive 77HP High Power Tone Generator) and a receiver (a 200GX Professional Series Inductive Amplifier). Both devices are available from Textron, Incorporated with offices in Providence, R.I. A typical application is to remove the breaker panel dead front (the sheet metal covering the breakers and buss bars in a typical service panel), remove the load side wires to a circuit under inspection, connect toner device with alligator clips to the ends of the conductors just removed from the load side of the breaker, thereby sending a generated tone throughout the circuit. Then using the receiver, which picks up the tone generated by the tone generator, the circuit wiring may be followed, even though it may be behind drywall. At any point the tone emitted from the receiver breaks, or dissipates, a short, ground fault or open circuit may be indicated. It is very dangerous to connect a toner to a circuit that is energized.

What is needed is a better device and method for heating-up buildings for making electrical inspections.

### SUMMARY OF THE INVENTION

The present invention provides a device and method for easily and safely providing temporary electric power to buildings to permit inspection of electrical circuits. The device is a power connector configured to safely and easily provide temporary power to a building unit through receptacles of a standard power meter socket. The connector has at least two spades, a GFCI circuit breaker with a male plug designed to connect the connector to a temporary power source at the electric potential needed for the building. For a typical residence in the United States, this would be a four-prong 120/240 volts ac plug. In preferred embodiments the power connector has the approximate shape of the back side of a standard power meter and the male plug is at the end of a short 120/240 four wire electric power cable. This preferred embodiment also includes three toner posts (two “hot” posts and one neutral post on the load side of the GFCI breaker) for application of a tone from a toner device. Also, in preferred embodiment a protective device is provided to prevent the circuit breaker from being closed unless the connector is installed in the power meter socket. This assures that no power is provided to the spades while they are exposed outside the power meter socket.

### BRIEF DESCRIPTION OF THE DRAWINGS

FIG. 1A is a side view of a preferred power connector for providing 120/240 volt ac temporary power for electrical circuit inspections of a typical United States residence.

FIG. 1B is a drawing showing the principal components of the above preferred power connector.

FIG. 1C shows a 120/240 four wire plug.

FIGS. 2A and 2B show features to permit toner checking of branch circuits.

FIGS. 3A and 3B show a preferred safety feature for preventing the breaker in the preferred connector from being closed unless the connector is properly installed in a power meter socket.

FIG. 4 is a prior art electric power meter socket.

### DETAILED DESCRIPTION OF PREFERRED EMBODIMENTS

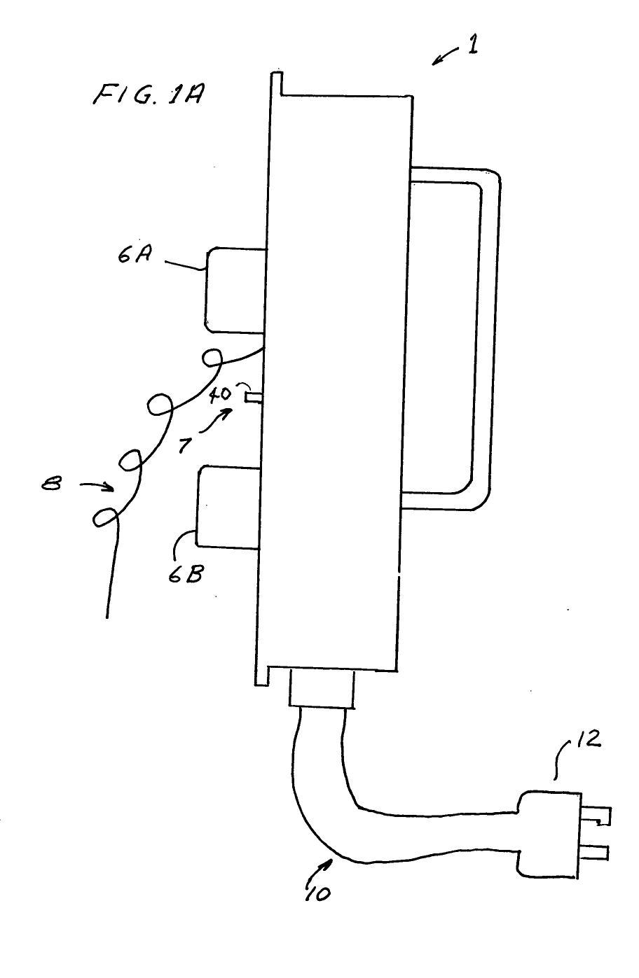

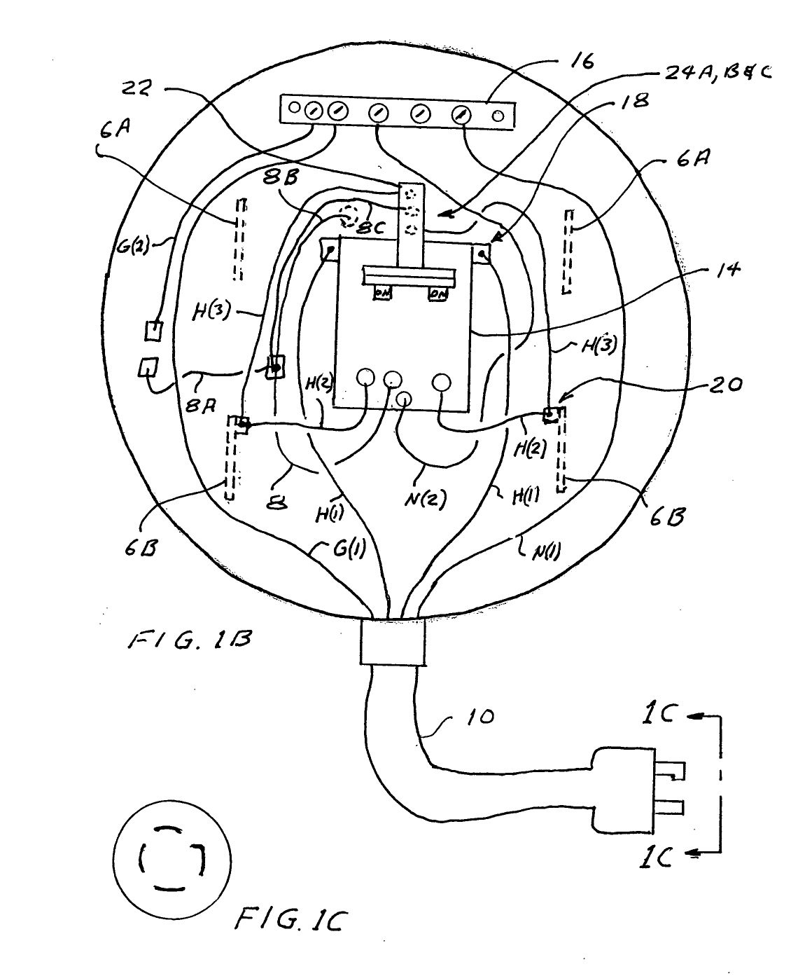

FIG. 1A is a side view of preferred Power Connector 1 for providing 120/240 volt ac temporary power for electrical circuit inspections of a typical United States building. The Power Connector includes two top spades 6A and two bottom spades 6B corresponding exactly to the four spades on a standard 120/240 volt power meter such as Model 720X070016, available from the General Electric Corporation, with offices in Fairfield, Conn. The top two spades 6A are not functional except to help position the Power Connector in the socket. The bottom two spades 6B make the Power Connector connection to two hot wires providing 240 volt input power. The Power Connector includes a neutral wire 8 is connected to a neutral bus that typically is located in the main breaker panel. The neutral is at ground potential or approximately at ground potential. Neutral wires along with one of the 240 volt wires provide the 120 potential. Shown in FIG. 1A and 1B is power cord 10 with 240 volt plug 12 for connecting the Power Connector to a 240 volt ac receptacle. Also shown at 7 in FIG. 1A is an extended piston 40 of trip circuit 7 that will be described in detail below.

FIG. 1B is a front view of the inside of the Power Connector showing the principal components of the connector. It includes GFCI breaker 14, Model Number GFCB230, available from the Eaton Corporation, with offices in Cleveland, Ohio. The four spades 6A and 6B are shown with dashed lines. The two hot wires H(1) from the temporary power supply are connected at the supply side of breaker 14 as shown at 18. The neutral wire N(1) from the line side of GFCI breaker in Power Connector 1 is connected to the neutral buss bar 16 within Power Connector 1. The neutral wire 8 from load side of GFCI breaker or circuitry preferably exits at the rear of the device and is fed down into the panel and is connected to a neutral buss within the main service panel (not shown). Ground wire G(1) from the supply (temporary power cord into device) is also connected to the neutral buss bar within Power Connector 1. Hot (240 volt) wires H(2) connect the output side of breaker 14 to spades 6B as shown at 20.

### Shock Protection

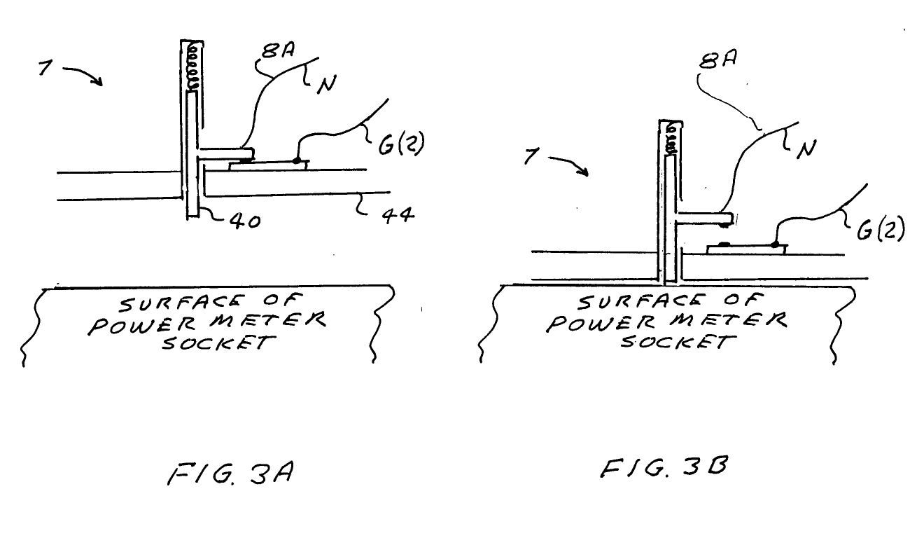

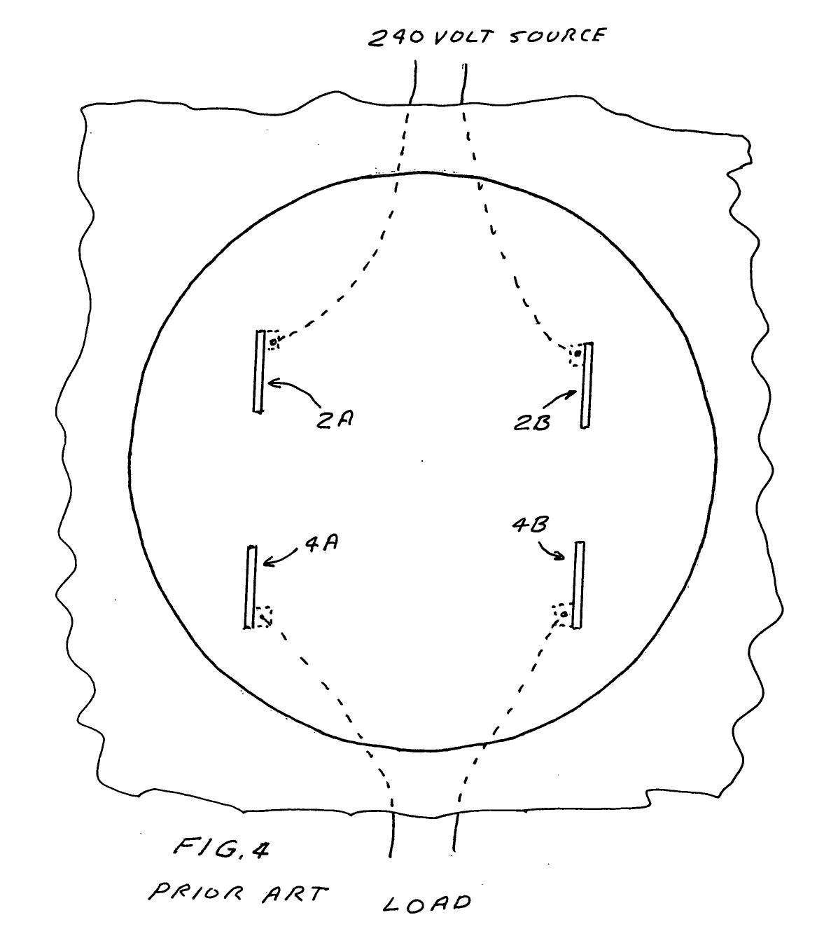

In preferred embodiments of the present invention, a protective feature is provided to prevent the circuit breaker from being closed unless the connector is installed in the power meter socket. A preferred feature is a trip circuit 7 that assures that no power is provided to spades 6B while they are exposed outside the power meter socket. Such a device is shown in FIGS. 3A and 3B with reference to FIGS. 1A and 1B. Piston 40 is spring loaded by spring 42 to extend out the back side of power connector as shown at 7 in FIG. 1A. As shown in FIG. 3A, when piston 40 is extended out beyond the frame 44 of power connector 1, neutral wire 8A (shown in FIG. 1B) makes contact with ground wire G(2) (also shown in FIG. 1B). This creates a ground fault that trips (opens) GFCI breaker 14 if it is energized (i.e., in the closed (on) position). When the power connector 1 is installed in the meter socket shown in FIG. 4, piston 40 will be shoved farther into the inside of power connector 1 and the connection between neutral wire 8A and ground wire G(2) will be broken. This will allow breaker 14 to be closed if it is not already closed.

### Branch Circuit Testing

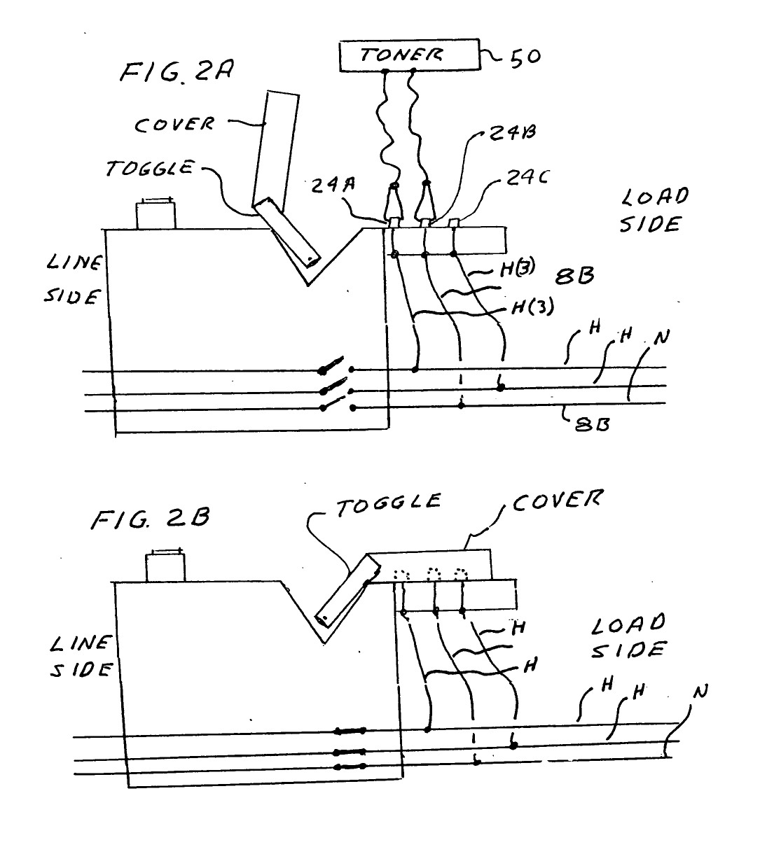

This preferred embodiment also includes toner posts to permit simplified branch circuit testing. Toner posts 24A, 24B and 24C are shown in FIG. 1B covered by toner post cover 22. These posts are also shown in FIG. 2A. As indicated in FIGS. 1B and 2A, toner posts 24A and 24C are connected to hot wires H(3) on the load side of breaker 14. Toner post 24B is connected to neutral wire 8B on the load side of breaker 14. As shown in FIG. 2B when breaker 14 is closed toner posts 24A, B and C are covered by cover 22 preventing use of the toner posts. Breaker 14 must be open as shown in FIG. 2A for the posts to be used. FIG. 2A shows alligator clips of toner 50 connected to posts 24A and 24B with breaker 14 open.

### The Heating Up and Inspection Process

The following is a brief description of the steps of a preferred process for accomplishing the heating up and inspection process for inspecting the electrical circuits in each unit of a typical residential development of, for example 50 single family dwelling units:
1) Electrical system is installed, per accepted plans and federal, state and local code, including finish devices (switches, receptacles, lights, etc).
2) Ensure all main and branch circuit breakers in panel are open, or “off”.
3) Insert the blades of the Power Connector into the jaws of the meter socket.
4) Plug the temporary power cord into a 240-volt receptacle to provide power to the building unit.
5) Close the GFCI breaker of the Power Connector.
6) Close the main breaker on panel.
7) Close each branch circuit breaker, individually
   Should there be a Ground Fault, causing the GFCI breaker of the Power Connector to open, open the branch circuit breaker if it is not already open. If it is already open, leave it open.
8) Reset GFCI breaker, or circuitry, on Device.
9) Continue closing branch circuit breakers
10) Once all “good” circuits are closed, (circuits with no Ground Faults, thereby allowing them to stay closed, or “on”, leave energized and move through system, manually verifying all devices (switches, receptacles, lights, etc) are functioning properly with proper voltages.
11) Return to service panel, and Power Connector.
12) Open all branch circuits found operable.

13) Open the main breaker on the panel.
14) Power off, or open, GFCI breaker or circuitry on the Power Connector.
15) Connect toner.
16) Close the main breaker.
17) Close circuit breaker on one of the branch circuits indicating ground faults in initial testing.
18) Turn toner on.
19) Follow bad circuit with receiver for toner, exercise standard electrical trouble shooting procedures for ground faults, shorts, or open circuits/conductors.
20) Once problem(s) have been identified and remedied using standard electrical trouble shooting and repair procedures, Turn off toner.
21) Repeat steps 15 through 20 for all circuits that indicated a ground fault in Steps 7.
22) Remove toner from Device.
23) After ensuring ALL branch and main circuit breakers on panel are open, or off, energize GFCI breaker, or circuitry, on the Power Connector.
24) Close main breaker on panel.
25) Energize breakers trouble shot and repaired, above.
26) Physically verify each and every device on said circuits to ensure effective repair to circuit.
27) Turn remaining, previously verified, branch circuits on, off, or open.
28) Open main circuit breaker on service panel.
29) Open GFCI breaker on Power Connector.
30) Unplug Power Connector from 240 volt receptacle.
31) Remove Power Connector from meter socket.
32) Electrical system is now released for formal inspection.
33) Once system has passed formal inspection, this system is released to local utility company for meter installation.

### Important Advantages

The present invention provides the following advantages over prior art techniques for testing electrical circuits for new buildings:
1) Will immediately indicate any and all ground fault conditions in home; not solely those circuits protected by GFCI devices.
2) Protects inspecting electrician and other workers from any bad neutral from load side of Device, (spades at rear).
3) Speeds up inspection process via increased diagnostics and shorter connection time.
4) Safeguards workers on a construction site from accidental disconnect of temporary power connection, or inadvertently transporting of connection device while energized.
5) Allows connection of toner device without removing breaker “dead front” or sheet metal covering breakers on panel for purposes of safety.
6) Allows connection of temporary power without removal of breaker dead front.
7) Prevents use of toner when system is energized. Use of toner on energized circuit will render it inoperable.
8) Provides GFCI protection to entire building during inspection process.

### Savings

Applicants estimate that the Power Connector will produce major savings of costs associated with electrical systems in new building construction. These include:
1) Reduction of informal inspection time by roughly 50%.
2) Reduces call backs, or warranty service work, due to ability to more readily detect deficiencies in electrical system that would otherwise go undetected.
3) Reduces, to a large degree, risk of future fires in homes due to any ground fault due to improper workmanship at time of installation.

### Variations

The present invention has been described above with respect to a residential unit with 120/240-volt electric service. These installations in terms of individual units represent about 95 percent of new construction in the United States. However, the present invention can equally well be applied to installations with other electric service such as 230-volt three phase, 460-volt three phase 277/480 volt three-phase. In each case a connector would preferably be provided with spades that correlate with those of the power meter to be installed when inspection is satisfactorily completed. Three phase application carries with it several notable differences; the male cord cap on the supply cord integral to the Power Connector would need to be of an appropriate design to match an appropriate supply cord from temporary power (for example, three phase 240V, the cord cap would have five prongs—three hots, a neutral, and a ground). The GFCI breaker would preferably be replaced with a standard three phase breaker. There would be seven spades on the rear of the Power Connector, with the top three not in use, the bottom three being hot to electrical system under test, and the horizontal spade being used for the purpose landing the load side neutral.

Although the present invention has been described above in terms of specific embodiments, persons skilled in the art will recognize that many changes and additions could be made without departing from the spirit of the invention. For example,
1) The connector could be manufactured to NEMA 3R specifications with an integral cover for the front of the device and a “drip” edge about the circumference of device.
2) GFCI circuitry could be miniaturized.
3) Protective mechanical device could be manufactured as an electronic mechanical device, automatically switching off power during toner use, or at time of connector disconnect.
4) Power Connectors could be completely reconfigured to have handles on side, switches for GFCI circuitry on outside circumference of device, allowing meter to be plugged into device, “sandwiching” device between meter and meter socket, for use in inspecting existing systems using utility power. This version could have an application for home inspectors during re-sale, or insurance premium negotiations. The connector might have Arc-Fault breakers, or circuitry, for assistance in detection arc-ing, or fouled contacts endemic to electrical systems subjected to normal operation.
5) Addition of Arc-Fault breakers, or circuitry, to Device for indication of any arcing or fouling of contacts within electrical system. While this may have little value for new system inspection, its application in testing existing electrical systems, as mentioned above (Item # 4), would be profound.

Therefore, the scope of the invention should be determined by the appended claims and their legal equivalence.

We claim:

1. A power connector for easily and safely providing temporary electric power to at least two receptacles of a standard power meter socket in order to permit inspection of electrical circuits of a building unit, said connector comprising:
A) at least two spades positioned to mate with the at least two receptacles of the power meter socket
B) a circuit breaker, and
C) a male plug designed to connect the connector to a temporary power source at the potential needed for the building unit.

2. The connector as in claim 1 wherein power connector has a shape corresponding approximately to a back side of a standard power meter.

3. The connector as in claim 1 wherein said circuit breaker is a GFCI circuit breaker.

4. The connector as in claim 1 and further comprising a protective means to prevent the circuit breaker from being closed unless the connector is installed in the power meter socket.

5. The connector as in claim 4 wherein said protective means comprises means for producing a ground fault unless the connector is inserted in a power meter socket.

6. The connector as in claim 5 wherein said protective means comprises a piston configured to break a grounding contact when the connector is inserted in the power meter socket.

7. The connector as in claim 4 wherein said protective means includes a mechanical means for preventing the circuit breaker from being opened unless the connector is installed in the power meter socket.

8. The connector as in claim 1 and further comprising a plurality of toner posts to apply “tones” for checking branch circuits.

9. The connector as in claim 6 wherein said posts are covered unless said breaker is open.

10. The connector as in claim 1 and further comprising a power cable connecting said male plug to said connector.

11. A method for heating-up and inspecting the electrical circuits of a building unit having a standard electric power meter socket with at least two power receptacles, said method comprising the steps of:
A) inserting into the socket a power connector comprising:
1) at least two spades positioned to mate with the at least two receptacles of the power meter socket,
2) a circuit breaker, and
3) a male plug designed to connect the connector to a temporary power source at the potential needed for the building unit.
B) plugging said male plug into a power receptacle to supply electrical power to the building unit for heat-up or inspection.

12. The method as in claim 11 wherein power connector has a shape corresponding approximately to a back side of a standard power meter.

13. The method as in claim 11 wherein said circuit breaker is a GFCI circuit breaker.

14. The method as in claim 11 wherein said connector further comprises a protective means to prevent the circuit breaker from being closed unless the connector is installed in the power meter socket.

15. The method as in claim 14 wherein said protective means comprises means for producing a ground fault unless the connector is inserted in a power meter socket.

16. The method as in claim 15 wherein said protective means comprises a piston configured to break a grounding contact when the connector is inserted in the power meter socket.

17. The method as in claim 14 wherein said protective means includes a mechanical means for preventing the circuit breaker from being opened unless the connector is installed in the power meter socket.

18. The method as in claim 11 wherein said connector further comprises a plurality of toner posts to apply “tones” for checking branch circuits.

19. The method as in claim 18 wherein said posts are covered unless said breaker is open.

20. The method as in claim 11 wherein said connector further comprises a power cable connecting said male plug to said connector.
